(19) United States
(12) Patent Application Publication
(10) Pub. No.: US 2023/0016744 A1
(43) Pub. Date: Jan. 19, 2023

(54) UPLINK DATA PLANE MANAGEMENT FOR QUALITY OF SERVICE DATA TRANSFER

(71) Applicant: ZEKU, INC., Palo Alto, CA (US)

(72) Inventors: Su-Lin LOW, San Diego, CA (US); Chun-I LEE, San Diego, CA (US); Tianan MA, San Diego, CA (US); Hong Kui YANG, San Diego, CA (US); Hausting HONG, San Diego, CA (US)

(21) Appl. No.: 17/947,467

(22) Filed: Sep. 19, 2022

Related U.S. Application Data
(63) Continuation of application No. PCT/US2021/020951, filed on Mar. 4, 2021.
(60) Provisional application No. 63/006,418, filed on Apr. 7, 2020.

(51) Int. Cl. H04W 36/00; H04W 36/30; H04W 36/08

(52) U.S. Cl. CPC H04W 36/00837; H04W 36/30; H04W 36/08

(57) ABSTRACT

Embodiments of apparatus and method for uplink data plane management are disclosed. In one example, a method for handover continuity can include buffering data packets at a user equipment based on a trigger event. The data packets can be mapped to first quality of service flows and associated with first radio resources at a source network node. The method can also include identifying second quality of service flows associated with second radio resources at a target network node. The method can further include remapping from the first quality of service flows to the second quality of service flows. The method can additionally include transmitting the buffered data packets from the user equipment toward the target node based on the remapping.

### CROSS-REFERENCE TO RELATED APPLICATIONS

This application is a continuation of International Application No. PCT/US2021/020951, filed Mar. 4, 2021, which claims the benefit of priority to U.S. Provisional Application No. 63/006,418, filed Apr. 7, 2020, entitled “5G HANDOVER UE UPLINK DATA PLANE MANAGEMENT SCHEME FOR LOSSLESS QOS DATA TRANSFER,” both of which are hereby incorporated by reference in their entireties.

### BACKGROUND

Embodiments of the present disclosure relate to apparatuses and methods for wireless communication.

Wireless communication systems are widely deployed to provide various telecommunication services such as telephony, video, data, messaging, and broadcasts. In wireless communications, there may be a transfer of a wireless device from one access node to another access node. For example, a wireless device running one or more applications may be handed off from a source access node to a target access node. The terms “handoff” and “handover” and various forms thereof may be used interchangeably to refer to this transfer.

### SUMMARY

Embodiments of apparatus and method for uplink data plane management are disclosed herein.

In one example, a method for handover continuity can include buffering data packets at a user equipment based on a trigger event. The data packets can be mapped to first quality of service flows and associated with first radio resources at a source network node. The method can also include identifying second quality of service flows associated with second radio resources at a target network node. The method can further include remapping from the first quality of service flows to the second quality of service flows. The method can additionally include transmitting the buffered data packets from the user equipment toward the target node based on the remapping.

In another example, an apparatus for handover continuity (for example, a user equipment) can include at least one processor and at least one memory including computer program code. The at least one memory and the computer program code can be configured to, with the at least one processor, cause the apparatus at least to buffer data packets at the user equipment based on a trigger event. The data packets can be mapped to first quality of service flows and associated with first radio resources at a source network node. The at least one memory and the computer program code can also be configured to, with the at least one processor, cause the apparatus at least to identify second quality of service flows associated with second radio resources at a target network node. The at least one memory and the computer program code can further be configured to, with the at least one processor, cause the apparatus at least to remap from the first quality of service flows to the second quality of service flows. The at least one memory and the computer program code can additionally be configured to, with the at least one processor, cause the apparatus at least to transmit the buffered data packets from the user equipment toward the target node based on the remapping.

In a further example, a non-transitory computer-readable medium can be encoded with instructions that, when executed in hardware of a user equipment, cause the user equipment to perform a process for handover continuity. The process can include buffering data packets at a user equipment based on a trigger event. The data packets can be mapped to first quality of service flows and associated with first radio resources at a source network node. The process can further include identifying second quality of service flows associated with second radio resources at a target network node. The process can additionally include remapping from the first quality of service flows to the second quality of service flows. The process can also include transmitting the buffered data packets from the user equipment toward the target node based on the remapping.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates an overview of the 5G base stations and network connections, in which certain embodiments of the present disclosure may be implemented.

FIG. 2 illustrates a method according to certain embodiments of the present disclosure.

FIG. 3 illustrates an uplink data plane management approach for loss-less quality of service (QoS) data transfer, according to certain embodiments of the present disclosure.

FIG. 4 provides a further illustration of a method of uplink data plane management according to certain embodiments of the present disclosure.

FIG. 5 illustrates a sequence flow of certain embodiments of the present disclosure.

FIG. 6 illustrates a block diagram of an apparatus including a baseband chip, a radio frequency chip, and a host chip, according to some embodiments of the present disclosure.

FIG. 7 illustrates an example node, in which some aspects of the present disclosure may be implemented, according to some embodiments of the present disclosure.

FIG. 8 illustrates an example wireless network, in which some aspects of the present disclosure may be implemented, according to some embodiments of the present disclosure.

Embodiments of the present disclosure will be described with reference to the accompanying drawings.

### DETAILED DESCRIPTION

Although specific configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of wireless communication systems will now be described with reference to various apparatus and methods. These apparatus and methods will be described in the following detailed description and illustrated in the accompanying drawings by various blocks, modules, units, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various wireless communication networks, such as code division multiple access (CDMA) system, time division multiple access (TDMA) system, frequency division multiple access (FDMA) system, orthogonal frequency division multiple access (OFDMA) system, single-carrier frequency division multiple access (SC-FDMA) system, and other networks. The terms “network” and “system” are often used interchangeably. A CDMA network may implement a radio access technology (RAT), such as Universal Terrestrial Radio Access (UTRA), CDMA 2000, etc. A TDMA network may implement a RAT, such as Global System for Mobile communication (GSM). An OFDMA network may implement a RAT, such as Long-Term Evolution (LTE) or New Radio (NR). The techniques described herein may be used for the wireless networks and RATs mentioned above, as well as other wireless networks and RATs.

In a fifth generation (5G) cellular wireless modem, a user equipment (UE) may be connected to a network that includes a variety of network nodes, including radio access nodes, for example, a base station (BS) or a next generation Node B (gNB). When a user equipment moves, or for other reasons, the user equipment may go from being connected to a source BS or gNB to a target BS or gNB by a process referred to as a handover. The user equipment may also be connected to or handed over to a fourth generation (4G) base station. The various access nodes of a 5G radio access network (RAN) may be connected to a user plane function (UPF) that hosts data plane connections to protocol data unit (PDU) sessions.

The user equipment may move around the network and/or radio network conditions may vary, for example due to the presence of additional devices in the area or other factors. Accordingly, the user equipment may periodically or sporadically perform measurements and potentially trigger a handover condition at the network (NW). An access and mobility function (AMF) in the network may trigger handover processing at the source and target BSs or other access nodes.

If handover occurs between 5G base stations, unsent DL data may be buffered at the source BS, and forwarded to the target BS. Once the handover execution is successfully completed, these DL buffered data may be transmitted to the UE for DL data continuity.

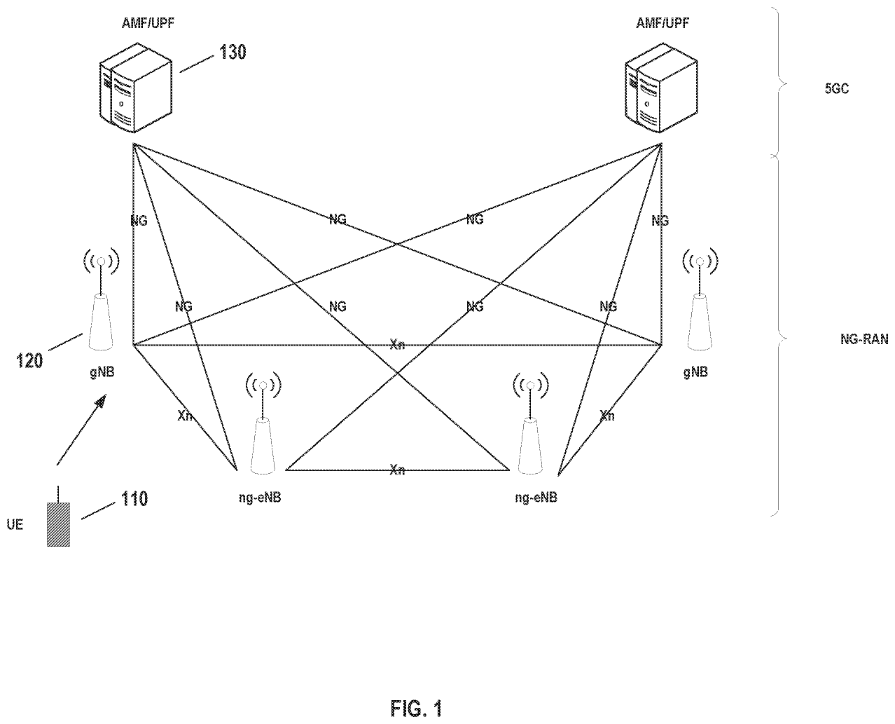

FIG. 1 is based on Third Generation Partnership Project (3GPP) Technical Specification (TS) 38.300, release 15 of which is hereby incorporated herein by reference. FIG. 1 illustrates an overview of the 5G base stations and network connections, in which certain embodiments of the present disclosure may be implemented. As mentioned below, although a 5G network is an example of a use case for certain embodiments, various embodiments may be applied to heterogeneous networks and to non-3GPP networks.

FIG. 1 illustrates that a user equipment 110 can be connected to a gNB 120, which may be connected with 5G core (5GC) network elements, such as AMF and UPF 130 over an interface labelled NG, and to other access nodes in a next generation radio access network (NG-RAN), such as other gNBs or next generation enhanced node B's (ng-eNBs) over an interface labelled Xn. These interfaces may be local interfaces or remote interfaces. For example, two gNBs may be jointly located in a single rack mounted system, and the Xn interface between them may be through a backplane. Alternatively, two gNBs may be located in separate locations, and the Xn interface between them may be over a microwave link, a fiber optic link, or the like.

In the NG-RAN, the gNB or ng-eNB may have responsibility for inter-cell radio resource management (RRM), radio bearer (RB) control, connection mobility control, radio admission control, measurement configuration and provision, and dynamic resource allocation, also known as scheduling.

By contrast, in the 5GC network, the AMF may have responsibility for network access stratum (NAS) security and idle state mobility handling. The session management function (SMF) (not explicitly shown in FIG. 1, but which may be co-located with the AMF and UPF) may have responsibility for user equipment internet protocol (IP) address allocation and PDU session control. The UPF may have responsibility for mobility anchoring and PDU handling. The UPF may also be connected to the Internet or other data networks (not illustrated).

Downlink (DL) data handling is described above. Typically, uplink (UL) handoff data is resumed at the target at the corresponding radio bearers if the same set of radio bearers are configured at the target base station as at the source base station.

If the target RBs are different from the source BS, there is typically no direct UL quality of service (QoS) flow data transfer from the source QoS flows to the target QoS flows.

In such cases, the packet data convergence protocol (PDCP) layer at the user equipment may be reestablished, and all source data (namely data that was in the process of being transmitted to the source node) may be flushed. Otherwise, for a lossless handover, unacknowledged and unsent data from all QoS flows may be queued for transmission at the target BS, on the default RBs configured.

One challenge in the 5G UL handoff at the UE, is how to ensure lossless and seamless handover of UL data packets from the source base station to the target BS, with distinction in the QoS flow priority. In previous approaches, there may be loss of UL data from the source BS during handover to the target BS, in case the target BS reconfigures the UE resources with completely different RBs. Additionally, there may be out-of-sequence data delivery to the target BS, in cases where the target base station's QoS to data radio bearer (DRB) mapping does not match the source base station's configurations. Moreover, there may be a loss of differentiated services of UL QoS flows when handover occurs from source to target BS. Furthermore, there may be a failure and long delay of UL low latency data packet transfer during handover. Additionally, there may be a loss of data continuity for high throughput continuous data transfer. Also, there may be ineffective user equipment handoff UL data transfer, leading to UE PDCP layer re-establishment and setup and increased UE power usage.

Certain embodiments of the present disclosure provide a 5G UL method at a user equipment for optimizing uplink handoff data transfer from a source to target base station with multiple QoS flows. Certain embodiments of a method may ensure lossless and seamless uplink data continuity, when handoff occurs from 5G to 4G, and even to non-3gpp base stations that host QoS flows. The lossless and seamless uplink data continuity may be useful for Ultra Reliable Low Latency Communication (URLLC) as well as high throughput applications.

Certain embodiments exert flow control on incoming uplink data sources, buffer all current QoS flow data, reconfigure the target resources, and remap the buffered QoS flow data onto the new target QoS-DRB resources. Once the handoff execution is completed, the buffered data can be transmitted out, and the flow control to incoming UL data sources can be lifted for the corresponding QoS flows.

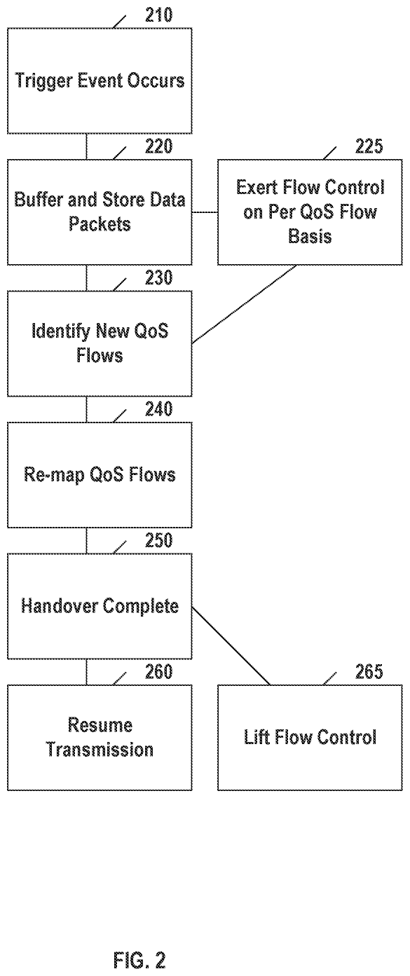

FIG. 2 illustrates a method according to certain embodiments of the present disclosure. FIG. 2 may provide a high-level overview of certain principles and aspects of certain embodiments that are described in more detail below.

As shown in FIG. 2, a method can include, at 210, a trigger event occurring. This trigger event can be a handover trigger. In other words, a user equipment or other device may detect that trigger event occurred, and consequently may cause the user equipment to attempt and/or conduct a handover. The handover can be said to be from a source node to a target node, for example, from a source base station or source access point such as a BS or gNB, to a target base station or target access point. The trigger event from the standpoint of the user equipment can be the reception of a radio resource reconfiguration message, which may indicate that the user equipment is to be handed over from the source access node to the target access node.

Upon the handover trigger at 210, at 220, the user equipment can buffer and store data packets for all QoS flows. The buffering and storing of the data packets can be performed with the data packets associated with a corresponding quality-of-service flow identifier. At 225, the user equipment can also exert flow control on all incoming data packets. Flow control can be implemented on a per-QoS flow basis. Exerting flow control can involve sending a flow control ON message from the baseband chip of the user equipment to the application(s) and/or host(s) of the user equipment.

As the handover progresses, the user equipment may, at 230, identify the new QoS flows and associated radio bearers and cell configurations. The new QoS may be provided by the target node. For example, as part of the handover procedure, the target node may indicate the QoS flows that are or will be available to the user equipment.

The identifying the second QoS flows associated with the second radio resources at the target network node can include mapping data radio bearers at the target node to second QoS flows matching or approximating the first QoS flows. The data radio bearers may be the same as or different from the data radio bearers at the source node.

At 240, the user equipment may remap the QoS flows used at the source node to the QoS at the target node. Together with the remapping of the QoS flows, the user equipment may also remap corresponding radio bearers, cell configurations, and any other necessary or desired parameters. The current QoS flows, namely those at the source node, can be matched as closely as possible to those at the target node.

At 250, handover may be deemed complete. The user equipment may be synchronized with the target node at this time. Accordingly, at 260, the user equipment can resume the transmission of the data buffered and/or stored at 220. Moreover, once the data buffer level drops below a threshold, the user equipment can resume IP flow data for a given QoS flow. Until, at 265, flow control is lifted, the user equipment can continue QoS per QoS flow to manage the buffered data and any new incoming UL data. The lifting of the flow control at 265 can be based on a determination, not shown, that the data buffer level is at or below the threshold.

Certain embodiments of the present disclosure, for example, relate to buffering and suspending all QoS flows upon handover. Upon a handover trigger, all QoS flows' data packets can be buffered and stored. The handover trigger event is illustrated at 210 in FIG. 2, whereas the buffering and storing of data packets is illustrated at 220 in FIG. 2. Flow control can be exerted on incoming data packet sources, as illustrated at 225 in FIG. 2.

Certain embodiments of the present disclosure, in another example, relate to the remapping of source data to new target QoS flows and radio bearers. Such remapping is illustrated at 240 in FIG. 2. With new target QoS flows (which may be identified at 230 in FIG. 2) and corresponding radio bearers and cell configurations, the current QoS flows can be remapped to the new set of resources directly or with a close match.

Certain embodiments of the present disclosure, in a further example, relate to the resumption of data traffic at a target base station with QoS priority. Once the handover is completed with the user equipment synchronized to the new target base station, buffered data can be resumed at the new base station with QoS priority. Handover completion is illustrated at 250 in FIG. 2, and resumption of transmission is illustrated at 260 in FIG. 2. In certain embodiments, flow control per QoS flow can be provided at uplink data source(s), with IP flow data resuming for a QoS flow after the data buffer level drops below a threshold. Exertion of flow control is illustrated at 225 in FIG. 2, whereas lifting of flow control is illustrated at 265 in the same figure.

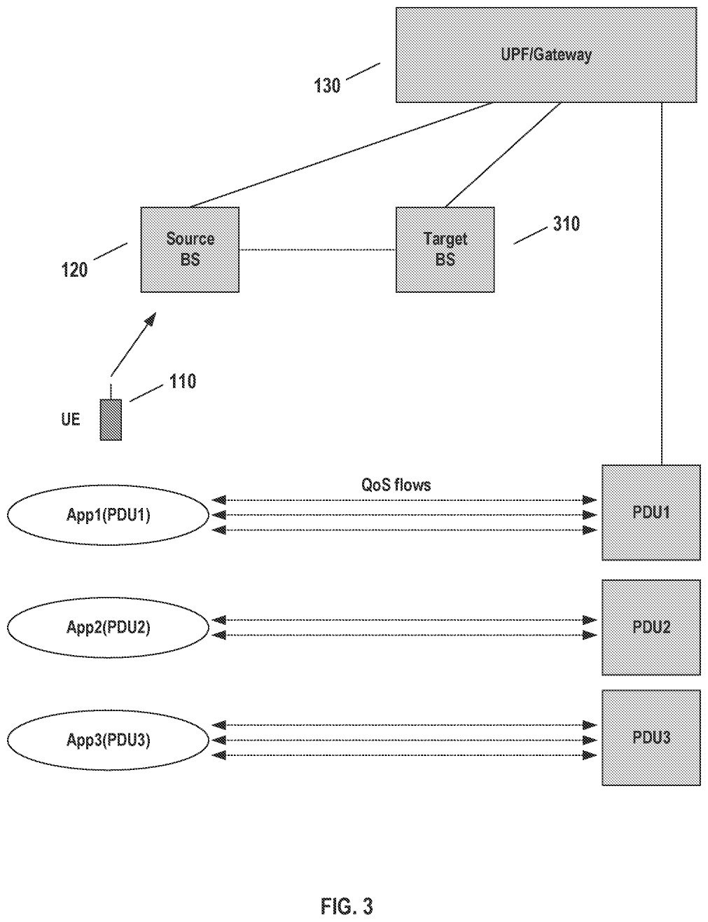

FIG. 3 illustrates an uplink data plane management approach for loss-less QoS data transfer, according to certain embodiments of the present disclosure. As shown in FIG. 3, a user equipment 110 (which may be the same as user equipment 110 in FIG. 1) may initially be connected to a source base station 120 (which may be gnB 120 in FIG. 1), and handover may be triggered to a target base station 310 (which may be any of the gNBs or ng-eNBs shown in FIG. 1). In this example, both base stations 120 and 310 are served by a common UPF or gateway 130 (which may be the same AMF/UPF shown in FIG. 1).

Thus, user equipment 110 can be connected in a network to a source base station 120, which is connected to a target base station 310, and both the base stations 120 and 310 may be connected to a common 5G UPF 130. The interfaces among the base stations 120 and 310 and UPF 130 may be as illustrated in FIG. 1. In another alternative, the source base station 120 and target base station 310 may also be connected through a non-5G network user plane gateway (shown as UPF/Gateway 130 in FIG. 3), where the user equipment 110 can be connected to the final end-to-end connections with multiple PDU sessions hosting applications with different quality-of-service differentiated services. One such configuration may be if the source base station 120 is handing over to a 4G, 3G, 2G, or non-3gpp network, where the data connectivity may be enabled through a common data server gateway.

At user equipment 110's baseband chip, incoming PDU data may be first mapped to QoS flows through an IP flow to QoS flow mapping, which can be configured for each PDU session setup through NAS traffic filter rules. The IP header tuple information (for example, source IP address, destination IP address, source IP port, destination IP port, IP type of service, and the like) can be filtered through a set of rules that determine the QoS flow identifier (QFI) of each IP flow. Multiple IP flows can be mapped to a QoS flow.

Once a QoS flow has been determined, a QoS to DRB flow mapping table can be used to look up the appropriate DRB for the QoS flow. The QoS to DRB flow mapping table can be configured through a service data adaptation protocol (SDAP) configuration during initial radio resource control (RRC) connection setup and reconfiguration at the user equipment. Each DRB may include one or several QoS flows, each with a distinct QoS profile. The DRBs can be served through a corresponding logical channel (LC), which can be scheduled for transmission on the uplink by a medium access control (MAC) uplink logical channel prioritization (LCP) scheduling mechanism, giving priority to low-latency, high-priority QoS flows in the higher priority DRBs.

In FIG. 3, three applications, App1, App2, and App3, are shown as having corresponding PDU sessions, PDU1, PDU2, and PDU3. In this example, and simply by way of illustration, App1 and App3 are shown as being mapped to three QoS flows, whereas App2 is shown as being mapped to two QoS flows.

As one example, when a target base station 310 has stronger measurements than the source base station 120, a handover can be triggered according to the handover criteria at the network. The source base station 120 can communicate with the target base station 310 to forward the source base station's UE baseband context information, as well as the UE's DL buffered data. Source base station 120 can trigger an RRC reconfiguration message to user equipment 110 to start handover execution.

Upon receipt of the RRC reconfiguration message, UE UL handover data plane management can occur according to certain embodiments of the present disclosure. First, the baseband chip of user equipment 110 can suspend each incoming data source from application processor (AP)/host chip and can buffer all the unacknowledged and unsent QoS data in each QoS flow. User equipment 110 can then reconfigure the target resources according to the received information, including QoS flows, radio bearers, QoS to DRB mapping, cell configurations, and target cell Id and access information. Next, the user equipment 110 can forward the buffered data from the source QoS flows to the target QoS flows, by running the target base station's QoS to DRB mapping. Finally, after synchronization to the target base station 310, user equipment 110 can resume QoS flow data transmission to target base station 310 and PDU sessions. The QoS priority of the handover data packets can be preserved and treated with differentiated services.

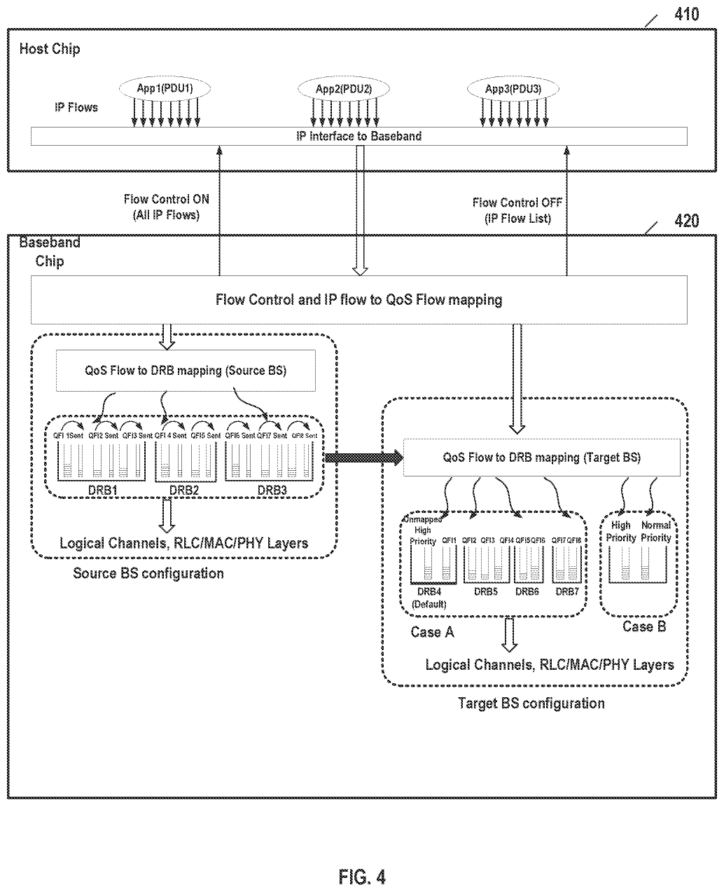

FIG. 4 provides a further illustration of a method of uplink data plane management according to certain embodiments of the present disclosure. A host chip 410 and a baseband chip 420 may be parts of user equipment 110. As shown in FIG. 4, a plurality of applications, designated as App1, App2, and App3 and corresponding to PDU1, PDU2, and PDU3, respectively, running on host chip 410 may generate IP flows and provide them to baseband chip 420 over an IP interface to baseband chip 420. Baseband chip 420 may perform IP flow to QoS flow mapping and may provide flow control on and off commands to host chip 410.

Baseband chip 420 may identify a source configuration and may determine a mapping between QoS flow and DRB for the source base station. For IP packets that are in process but not yet sent or not yet acknowledged, baseband chip 420 may buffer these packets, keeping track of the QFI(s) corresponding to each DRB. In this example, DRB1, DRB2, and DRB3 are present at the source base station side. QFI1, QFI2, and QFI3, each with some data unsent and some data unacknowledged, are mapped to DRB1. QFI4 and QFI5, each with some data unsent and some data unacknowledged, are mapped to DRB2. QFI6, QFI7, and QFI8, each with some data unsent and some data unacknowledged, are mapped to DRB3. These DRBs may be further associated with various logical channels and may proceed in radio link control (RLC), MAC, and PHY layers.

Baseband chip 420 may also identify a target configuration and determine a mapping between QoS flow and DRB for the target base station. Two cases are shown: Case A and Case B, which are designated this way merely for convenience and not by way of expressing order or priority. In this example in Case A, DRB4 (a default radio bearer) is mapped to QFI1 and also to all unmapped high priority packets. DRB5 is mapped to QFI2, QFI3, and QFI4. DRB6 is mapped to QFI5 and QFI6. DRB7 is mapped to QFI7 and QFI8.

As illustrated in this case, four DRBs in the target correspond to the three DRBs in the source. Other mappings are also possible. In Case B, there are simply two queues corresponding to high priority and normal priority. In either case A or case B, the processing may proceed to mapping to logical channels, and passing through the protocol stack to RLC, MAC, and PHY layers.

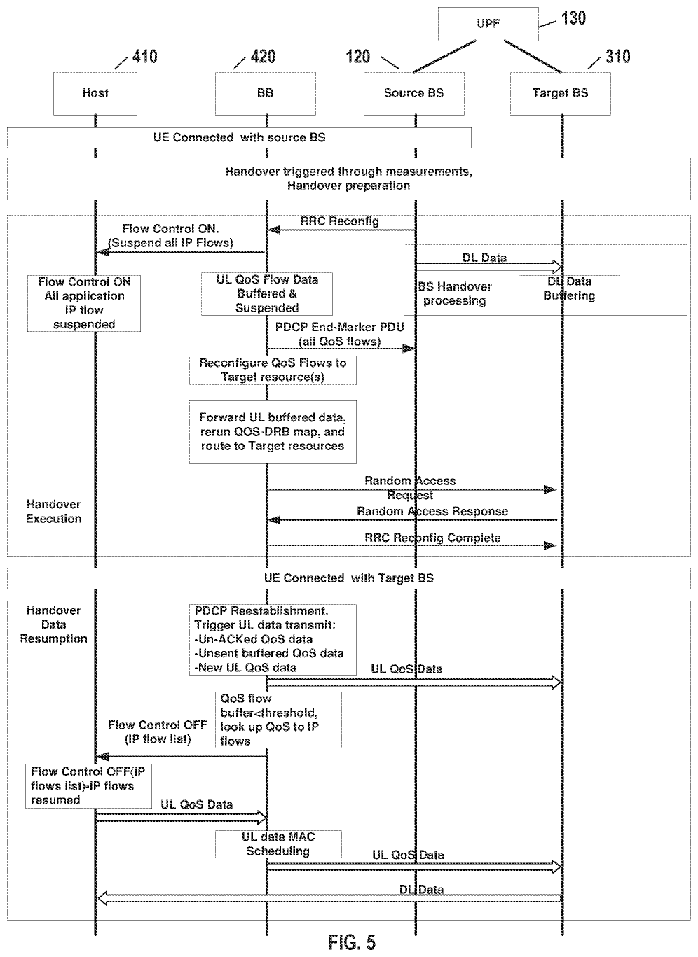

FIG. 5 illustrates a sequence flow of certain embodiments of the present disclosure. As shown from the top of FIG. 5, baseband chip 420 of user equipment 110 may initially be connected with source base station 120 (these may be the same as the previously mentioned user equipment 110 and source base station 120 in FIG. 3). Next, a handover trigger may occur. This handover may be based on measurement results, as mentioned above, or by any other criteria. The network may, therefore, send an RRC Reconfigure message to baseband chip 420 of user equipment 110. Reception of the RRC reconfiguration message can be the trigger, from the standpoint of baseband chip 420 of user equipment 110, that handover is to be executed.

In certain embodiments, baseband chip 420 of user equipment 110 can suspend all data transmission on the source DRB resources immediately. Baseband chip 420 of user equipment 110 can turn on flow control with respect to host chip 410 of user equipment 110 by sending a Flow Control ON message to host chip 410 to suspend all IP flows.

All uplink QoS flow data can be buffered, including un-acknowledged and unsent data in each QoS flow. In parallel, source base station 120 may be transferring any incoming DL data for baseband chip 420 of user equipment 110 to target base station 310. Target base station 310 may perform DL data buffering for this data. Other handover processing can occur at this time as well.

Baseband chip 420 of user equipment 110 can send a PDCP End-Marker Control PDU for each QoS flow to inform source base station 120 that baseband chip 420 of user equipment 110 ceases the QoS to DRB mapping of each QoS flow at this source BS 120.

Baseband chip 420 of user equipment 110 can also reconfigure the QoS flows to target resources. In particular, for each QoS flow, baseband chip 420 may identify the radio bearer, cell configuration, and the like that may correspond. More particularly, upon RRC Reconfig receipt, baseband chip 420 can reconfigure a new set of target QoS to DRB mapping, new target DRB resources, Cell Config, and logical channels.

The RRC Reconfigure message, which may be sent according to 3GPP TS 38.311, can provide target information including target cell ID, radio bearer configuration (this may be the same DRB resource as source base station 120, or may be a different set of DRB resources from source base station 120), cell group configuration (this may specify resources for carrier aggregation and component carriers), QoS to data radio bearer mapping (even if the DRB resource pipe remains the same as the source, the QoS to DRB mapping may be different), security parameters (broadly including, for example, ciphering and Integrity algorithm and ciphering and integrity keys), cell radio network temporary identifier (C-RNTI) at the target, random access channel (RACH) resources such as pre-assigned preambles for physical random access channel (PRACH) access at the target cells, and system information of the target cell. From the network point of view, if the source of the UL data terminates at the same UPF or PDU, the QoS flows for the PDU session may remain the same but may be routed through different DRB(s) at the target base station's network.

Once baseband chip 420 of user equipment 110 has reconfigured the QoS flows to the target resources, baseband chip 420 can forward UL buffered data to target resources. For example, in certain embodiments, baseband chip 420 can remap source QoS data flows to target resources. For example, baseband chip 420 can re-run target QoS flow to DRB mapping to determine target new RB/resources for each QoS flow data. Un-acknowledged packets can be queued first, followed by unsent packets for each QoS flow.

As mentioned above, there may be at least two different cases, which are labelled for convenience as Case A and Case B. In Case A, the target base station 310 may be a 5G base station. In this case, the same QoS flow may be provided with newly configured DRB and LC resource(s) at the target. Hence packets may be routed to this exact QoS flow and DRB.

If no matching QoS configuration exists for the QoS flow, the QoS flow profile can be used to determine if high priority low-latency (LL) packets need to be placed in a high priority default QoS flow queue, where the data will be sent at the highest priority first, when the target MAC UL scheduling algorithm is triggered for UL transmission.

In case B, target base station 310 may be 4G, 3G, 2G, or other non-3GPP. If no equivalent/matching QoS configuration exists for the QoS flow, the QoS flow profile can be used to determine if high priority LL packets need to be placed in a high priority default QoS flow queue, where the data will be sent at the highest priority first. The rest of the packets can be queued in a separate default non-high priority queue, where the QoS profile score can be used to determine the priority of transmission.

Baseband chip 420 of user equipment 110 may execute the handoff by triggering a Contention Free Random Access (CFRA) procedure per 3GPP standards (including random access request and response(s)), using a pre-assigned PRACH preamble given in the RRC Reconfig message. Once the CFRA is successful, baseband chip 420 of user equipment 110 can be considered synced and connected to the target base station.

Baseband chip 420 of user equipment 110 can then perform PDCP re-establishment. Baseband chip 420 can trigger UL data transmission for unacknowledged QoS data, unsent buffered QoS data, and new UL QoS data using grant requests.

In certain embodiments, source handoff data can be transmitted out according to the LC priority per QoS flow in each RB. The packets can be transmitted in the following order per QoS flow: unacknowledged packets from the source and then unsent packets from the source.

At each QoS flow queue, once the QoS flow buffer level falls below a threshold, flow control to host chip 410 of user equipment 110 can be triggered to turn off. A QoS flow to IP flow mapping can be looked up to retrieve the list of IP flows corresponding to a given QoS flow.

Flow control can then be un-asserted for each of the IP flows in the IP flow list corresponding to the QoS flow that has buffered data reduced below the threshold setting. Subsequently, new application data from host chip 410 of user equipment 110 for these IP flows that are incoming can be queued into the corresponding QoS flow queues to be sent out after the existing source data are pushed out.

Thus, certain embodiments allow a user equipment to effectively perform 5G UL handoff with a lossless, seamless, in-sequence and optimized QoS flow data transfer with differentiated services and may enhance the UE performance, especially for Ultra Reliable Low Latency Communication (URLLC) applications.

Certain embodiments may have various benefits and/or advantages. For example, certain embodiments may be practical and straightforward to implement in software running on user equipment hardware. Certain embodiments may ensure lossless UL data transfer when handoff occurs from a source base station to a target base station. Certain embodiments also provide for differentiated services with optimized QoS priority of each UL QoS flow when handoff occurs from a source base station to a target base station. Additionally, certain embodiments may provide improved user equipment handoff performance with UL data continuity. Moreover, in certain embodiments, low latency QoS flows are prioritized for UL delivery at the target, even if matching QoS flows or DRBs at the target are not distinguished by the target BS resources. Additionally, certain embodiments may prevent data loss with flow control that allows suspension of source data before handover. Certain embodiments may also expedite QoS data resumption, with new data after handoff resuming on a per QoS flow basis using mapping of QoS flow to the source IP flow(s). Certain embodiments may also eliminate UL data buffer overflow and data loss at a user equipment during handoff. Also, certain embodiments may eliminate out-of-sequence data delivery for each QoS flow with best-matched target radio bearer and cell configurations during handoff. Furthermore, certain embodiments may provide generic and optimized uplink data transfer when handoff occurs from 5G to 4G or non-3GPP base stations.

Various modifications of certain embodiments are possible. For example, certain embodiments may be applied to an uplink handoff data management scheme to inter-RAT between 5G and 2G/3G or non-3GPP systems where there are no QoS configurations by prioritizing data transfer for the highest QoS latency flows. Certain embodiments can likewise be modified to allow non-3GPP, 4G/3G/2G handoff back to a QoS enabled 5G system, with optimized QoS flow transfer.

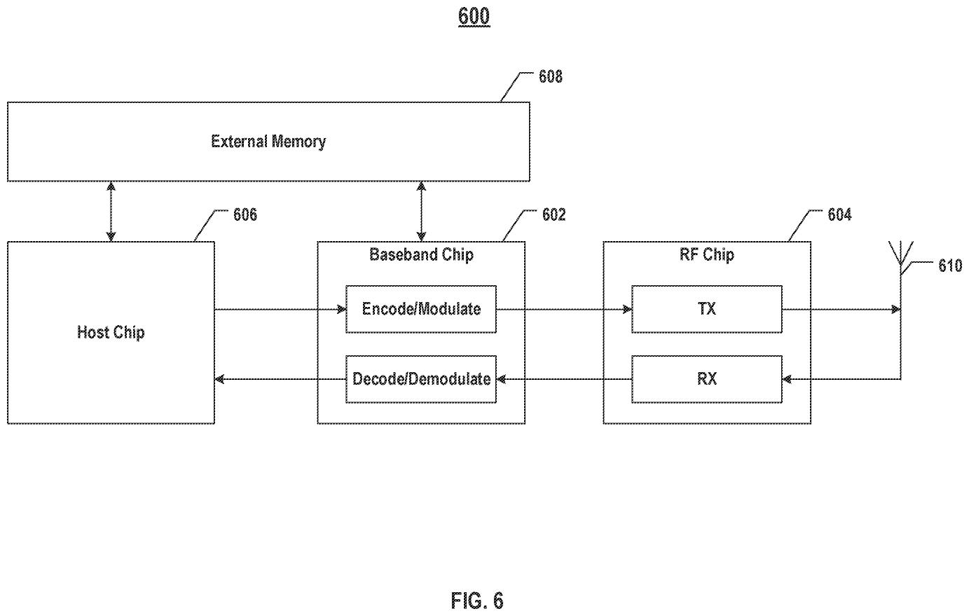

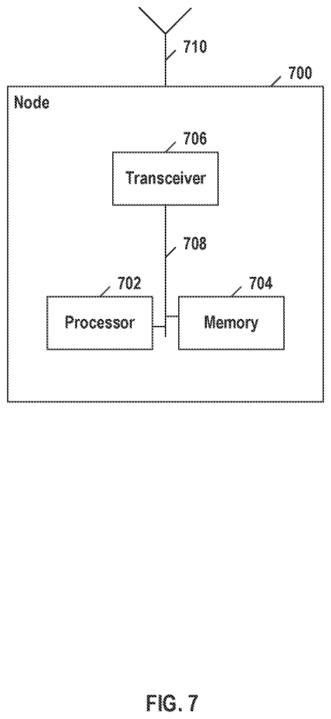

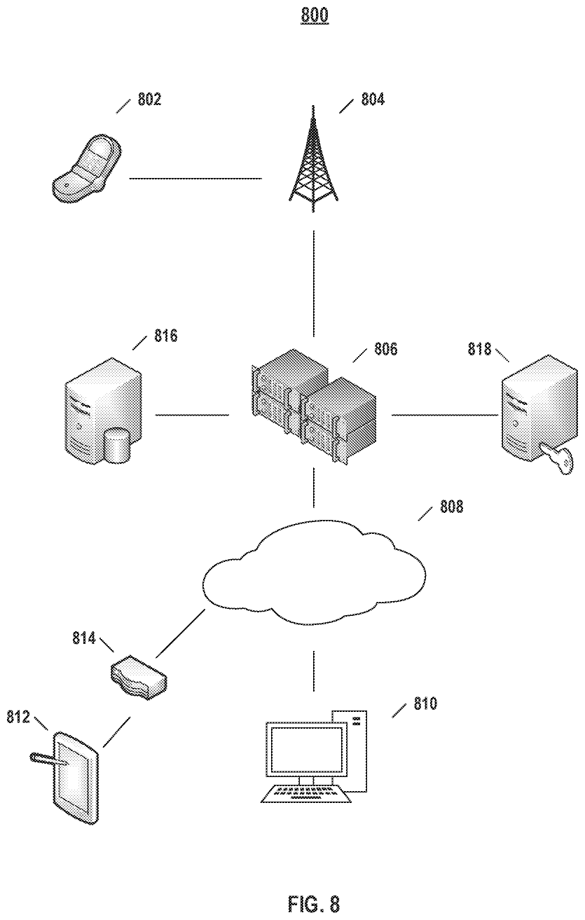

The software and hardware methods and systems disclosed herein, such as the methods illustrated in FIGS. 2 through 5 may be implemented by any suitable nodes in a wireless network. For example, FIGS. 6 and 7 illustrate respective apparatuses 600 and 700, and FIG. 8 illustrates an exemplary wireless network 800, in which some aspects of the present disclosure may be implemented, according to some embodiments of the present disclosure.

FIG. 6 illustrates a block diagram of an apparatus 600 including a baseband chip 602, a radio frequency chip 604, and a host chip 606, according to some embodiments of the present disclosure. Apparatus 600 may be an example of any suitable node of wireless network 800 in FIG. 8, such as user equipment 802 or network node 804. As shown in FIG. 6, apparatus 600 may include baseband chip 602, radio frequency chip 604, host chip 606, and one or more antennas 610. In some embodiments, baseband chip 602 is implemented by processor 702 and memory 704, and radio frequency chip 604 is implemented by processor 702, memory 704, and transceiver 706, as described below with respect to FIG. 7. In certain embodiments, baseband chip 602 may, in whole or in part, implement the methods and generate and process the messages shown in FIGS. 2-5. For example, baseband chip 602 in a user equipment may perform the UE steps, generate the UE messages, and the like, while host chip 606 may perform the AP/host steps, provide data packets in IP flows to baseband chip 602, receive flow control commands, and perform flow control based on the commands Baseband chip 602 can correspond to baseband chip 420 in FIG. 4, while host chip 606 may correspond to host chip 410 in FIG. 4. Besides the on-chip memory (also known as “internal memory” or “local memory,” e.g., registers, buffers, or caches) on each chip 602, 604, or 606, apparatus 600 may further include an external memory 608 (e.g., the system memory or main memory) that can be shared by each chip 602, 604, or 606 through the system/main bus. Although baseband chip 602 is illustrated as a standalone SoC in FIG. 6, it is understood that in one example, baseband chip 602 and radio frequency chip 604 may be integrated as one SoC; in another example, baseband chip 602 and host chip 606 may be integrated as one SoC; in still another example, baseband chip 602, radio frequency chip 604, and host chip 606 may be integrated as one SoC, as described above.

In the uplink, host chip 606 may generate raw data and send it to baseband chip 602 for encoding, modulation, and mapping. As mentioned above, the data from host chip 606 may be associated with various IP flows. Baseband chip 602 may map those IP flows to QoS flows and perform additional data plane management functions, as described above. Baseband chip 602 may also access the raw data generated by host chip 606 and stored in external memory 608, for example, using the direct memory access (DMA). Baseband chip 602 may first encode (e.g., by source coding and/or channel coding) the raw data and modulate the coded data using any suitable modulation techniques, such as multi-phase pre-shared key (MPSK) modulation or quadrature amplitude modulation (QAM). Baseband chip 602 may perform any other functions, such as symbol or layer mapping, to convert the raw data into a signal that can be used to modulate the carrier frequency for transmission. In the uplink, baseband chip 602 may send the modulated signal to radio frequency chip 604. Radio frequency chip 604, through the transmitter (Tx), may convert the modulated signal in the digital form into analog signals, i.e., radio frequency signals, and perform any suitable front-end radio frequency functions, such as filtering, up-conversion, or sample-rate conversion. Antenna 610 (e.g., an antenna array) may transmit the radio frequency signals provided by the transmitter of radio frequency chip 604.

In the downlink, antenna 610 may receive radio frequency signals and pass the radio frequency signals to the receiver (Rx) of radio frequency chip 604. Radio frequency chip 604 may perform any suitable front-end radio frequency functions, such as filtering, down-conversion, or sample-rate conversion, and convert the radio frequency signals into low-frequency digital signals (baseband signals) that can be processed by baseband chip 602. In the downlink, baseband chip 602 may demodulate and decode the baseband signals to extract raw data that can be processed by host chip 606. Baseband chip 602 may perform additional functions, such as error checking, de-mapping, channel estimation, descrambling, etc. The raw data provided by baseband chip 602 may be sent to host chip 606 directly or stored in external memory 608.

As shown in FIG. 7, a node 700 may include a processor 702, a memory 704, a transceiver 706. These components are shown as connected to one another by bus 708, but other connection types are also permitted. When node 700 is user equipment 802, additional components may also be included, such as a user interface (UI), sensors, and the like. Similarly, node 700 may be implemented as a blade in a server system when node 700 is configured as core network element 806. Other implementations are also possible.

Transceiver 706 may include any suitable device for sending and/or receiving data. Node 700 may include one or more transceivers, although only one transceiver 706 is shown for simplicity of illustration. An antenna 710 is shown as a possible communication mechanism for node 700. Multiple antennas and/or arrays of antennas may be utilized. Additionally, examples of node 700 may communicate using wired techniques rather than (or in addition to) wireless techniques. For example, network node 804 may communicate wirelessly to user equipment 802 and may communicate by a wired connection (for example, by optical or coaxial cable) to core network element 806. Other communication hardware, such as a network interface card (NIC), may be included as well.

As shown in FIG. 7, node 700 may include processor 702. Although only one processor is shown, it is understood that multiple processors can be included. Processor 702 may include microprocessors, microcontrollers, digital signal processors (DSPs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Processor 702 may be a hardware device having one or many processing cores. Processor 702 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software. Processor 702 may be a baseband chip, such as baseband chip 602 in FIG. 6. Node 700 may also include other processors, not shown, such as a central processing unit of the device, a graphics processor, or the like. Processor 702 may include internal memory (also known as local memory, not shown in FIG. 7) that may serve as memory for L2 data. Processor 702 may include a radio frequency chip, for example, integrated into a baseband chip, or a radio frequency chip may be provided separately. Processor 702 may be configured to operate as a modem of node 700, or may be one element or component of a modem. Other arrangements and configurations are also permitted.

As shown in FIG. 7, node 700 may also include memory 704. Although only one memory is shown, it is understood that multiple memories can be included. Memory 704 can broadly include both memory and storage. For example, memory 704 may include random-access memory (RAM), read-only memory (ROM), static RAM (SRAM), dynamic RAM (DRAM), ferro-electric RAM (FRAM), electrically erasable programmable ROM (EEPROM), CD-ROM or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 702. Broadly, memory 704 may be embodied by any computer-readable medium, such as a non-transitory computer-readable medium. The memory 704 can be the external memory 608 in FIG. 6. The memory 704 may be shared by processor 702 and other components of node 700, such as the unillustrated graphic processor or central processing unit.

As shown in FIG. 8, wireless network 800 may include a network of nodes, such as a UE 802, a network node 804, and a core network element 806. User equipment 802 may be any terminal device, such as a mobile phone, a desktop computer, a laptop computer, a tablet, a vehicle computer, a gaming console, a printer, a positioning device, a wearable electronic device, a smart sensor, or any other device capable of receiving, processing, and transmitting information, such as any member of a vehicle to everything (V2X) network, a cluster network, a smart grid node, or an Internet-of-Things (IoT) node. It is understood that user equipment 802 is illustrated as a mobile phone simply by way of illustration and not by way of limitation.

Network node 804 may be a device that communicates with user equipment 802, such as a wireless access point, a base station (BS), a Node B, an enhanced Node B (eNodeB or eNB), a next-generation NodeB (gNodeB or gNB), a cluster master node, or the like. Network node 804 may have a wired connection to user equipment 802, a wireless connection to user equipment 802, or any combination thereof. Network node 804 may be connected to user equipment 802 by multiple connections, and user equipment 802 may be connected to other access nodes in addition to network node 804. Network node 804 may also be connected to other UEs. It is understood that network node 804 is illustrated by a radio tower by way of illustration and not by way of limitation.

Core network element 806 may serve network node 804 and user equipment 802 to provide core network services. Examples of core network element 806 may include a home subscriber server (HSS), a mobility management entity (MME), a serving gateway (SGW), or a packet data network gateway (PGW). These are examples of core network elements of an evolved packet core (EPC) system, which is a core network for the LTE system. Other core network elements may be used in LTE and in other communication systems. In some embodiments, core network element 806 includes an access and mobility management function (AMF) device, a session management function (SMF) device, or a user plane function (UPF) device, of a core network for the NR system. It is understood that core network element 806 is shown as a set of rack-mounted servers by way of illustration and not by way of limitation.

Core network element 806 may connect with a large network, such as the Internet 808, or another IP network, to communicate packet data over any distance. In this way, data from user equipment 802 may be communicated to other UEs connected to other access points, including, for example, a computer 810 connected to Internet 808, for example, using a wired connection or a wireless connection, or to a tablet 812 wirelessly connected to Internet 808 via a router 814. Thus, computer 810 and tablet 812 provide additional examples of possible UEs, and router 814 provides an example of another possible access node.

A generic example of a rack-mounted server is provided as an illustration of core network element 806. However, there may be multiple elements in the core network including database servers, such as a database 816, and security and authentication servers, such as an authentication server 818. Database 816 may, for example, manage data related to user subscription to network services. A home location register (HLR) is an example of a standardized database of subscriber information for a cellular network. Likewise, authentication server 818 may handle authentication of users, sessions, and so on. In the NR system, an authentication server function (AUSF) device may be the specific entity to perform user equipment authentication. In some embodiments, a single server rack may handle multiple such functions, such that the connections between core network element 806, authentication server 818, and database 816, may be local connections within a single rack.

Each of the elements of FIG. 8 may be considered a node of wireless network 800. More detail regarding the possible implementation of a node is provided by way of example in the description of a node 700 in FIG. 7 above. Node 700 may be configured as user equipment 802, network node 804, or core network element 806 in FIG. 8. Similarly, node 700 may also be configured as computer 810, router 814, tablet 812, database 816, or authentication server 818 in FIG. 8.

In various aspects of the present disclosure, the functions described herein may be implemented in hardware, software, firmware, or any combination thereof. If implemented in software, the functions may be stored on or encoded as instructions or code on a non-transitory computer-readable medium. Computer-readable media includes computer storage media. Storage media may be any available media that can be accessed by a computing device, such as node 700 in FIG. 7. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, includes CD, laser disc, optical disc, DVD, and floppy disk where disks usually reproduce data magnetically, while discs reproduce data optically with lasers. Combinations of the above should also be included within the scope of computer-readable media.

According to one aspect of the present disclosure, a method for handover continuity can include buffering data packets at a user equipment based on a trigger event. The data packets can be mapped to first quality of service flows and associated with first radio resources at a source network node. The method can also include identifying second quality of service flows associated with second radio resources at a target network node. The method can further include remapping from the first quality of service flows to the second quality of service flows. The method can additionally include transmitting the buffered data packets from the user equipment toward the target node based on the remapping.

In some embodiments, the method can further include exerting flow control on a per-quality-of-service-flow basis on all data packets arriving at a baseband chip of a user equipment. The exerting flow control can be responsive to the trigger event.

In some embodiments, the method can further include lifting the flow control when a data buffer comprising the buffered data packets drops below a threshold.

In some embodiments, the lifting the flow control can include selectively lifting flow control on a per-internet-protocol-flow basis based on an association with the second quality of service flows.

In some embodiments, the data packets can be mapped to the first quality of service flows using internet protocol flow to quality of service flow mapping.

In some embodiments, the trigger event can be reception of a radio reconfiguration message indicative of a handover.

In some embodiments, the identifying the second quality of service flows associated with the second radio resources at the target network node can include mapping data radio bearers at the target node to second quality of service flows matching or approximating the first quality of service flows.

According to another aspect of the present disclosure, an apparatus for handover continuity (for example, a user equipment) can include at least one processor and at least one memory including computer program code. The at least one memory and the computer program code can be configured to, with the at least one processor, cause the apparatus at least to buffer data packets at the user equipment based on a trigger event. The data packets can be mapped to first quality of service flows and associated with first radio resources at a source network node. The at least one memory and the computer program code can also be configured to, with the at least one processor, cause the apparatus at least to identify second quality of service flows associated with second radio resources at a target network node. The at least one memory and the computer program code can further be configured to, with the at least one processor, cause the apparatus at least to remap from the first quality of service flows to the second quality of service flows. The at least one memory and the computer program code can additionally be configured to, with the at least one processor, cause the apparatus at least to transmit the buffered data packets from the user equipment toward the target node based on the remapping.

In some embodiments, the at least one memory and the computer program code can further be configured to, with the at least one processor, cause the apparatus at least to exert flow control on a per-quality-of-service-flow basis on all data packets arriving at a baseband chip of a user equipment. The exerting flow control can be responsive to the trigger event.

In some embodiments, the at least one memory and the computer program code can further be configured to, with the at least one processor, cause the apparatus at least to lift the flow control when a data buffer comprising the buffered data packets drops below a threshold.

In some embodiments, the lifting the flow control comprises selectively lifting flow control on a per-internet-protocol-flow basis based on an association with the second quality of service flows.

In some embodiments, the data packets are mapped to the first quality of service flows using internet protocol flow to quality of service flow mapping.

In some embodiments, the trigger event can be reception of a radio reconfiguration message indicative of a handover.

In some embodiments, the identifying the second quality of service flows associated with the second radio resources at the target network node can include mapping data radio bearers at the target node to second quality of service flows matching or approximating the first quality of service flows.

According to a further aspect of the present disclosure, a non-transitory computer-readable medium can be encoded with instructions that, when executed in hardware of a user equipment, cause the user equipment to perform a process for handover continuity. The process can include buffering data packets at a user equipment based on a trigger event. The data packets can be mapped to first quality of service flows and associated with first radio resources at a source network node. The process can further include identifying second quality of service flows associated with second radio resources at a target network node. The process can additionally include remapping from the first quality of service flows to the second quality of service flows. The process can also include transmitting the buffered data packets from the user equipment toward the target node based on the remapping.

In some embodiments, the process can further include exerting flow control on a per-quality-of-service-flow basis on all data packets arriving at a baseband chip of a user equipment, wherein the exerting flow control is responsive to the trigger event.

In some embodiments, the process can further include lifting the flow control when a data buffer comprising the buffered data packets drops below a threshold.

In some embodiments, the lifting the flow control can include selectively lifting flow control on a per-internet-protocol-flow basis based on an association with the second quality of service flows.

In some embodiments, the data packets can be mapped to the first quality of service flows using internet protocol flow to quality of service flow mapping.

In some embodiments, the trigger event can be reception of a radio reconfiguration message indicative of a handover.

In some embodiments, the identifying the second quality of service flows associated with the second radio resources at the target network node can include mapping data radio bearers at the target node to second quality of service flows matching or approximating the first quality of service flows.

The foregoing description of the specific embodiments will so reveal the general nature of the present disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The particular arrangements provided are illustrative and without limitation. Accordingly, the functional blocks, modules, and steps may be re-ordered or combined in different ways than in the examples provided above. Likewise, certain embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

What is claimed is:

1. A method for handover continuity, comprising:
buffering data packets at a user equipment based on a trigger event, wherein the data packets are mapped to first quality of service flows and associated with first radio resources at a source network node;
identifying second quality of service flows associated with second radio resources at a target network node;
remapping from the first quality of service flows to the second quality of service flows; and
transmitting the buffered data packets from the user equipment toward the target network node based on the remapping.

2. The method of claim 1, further comprising:
exerting flow control on a per-quality-of-service-flow basis on all data packets arriving at a baseband chip of a user equipment, wherein the exerting flow control is responsive to the trigger event.

3. The method of claim 2, further comprising:
lifting the flow control when a data buffer comprising the buffered data packets drops below a threshold.

4. The method of claim 3, wherein the lifting the flow control comprises selectively lifting flow control on a per-internet-protocol-flow basis based on an association with the second quality of service flows.

5. The method of claim 1, wherein the data packets are mapped to the first quality of service flows using internet protocol flow to quality of service flow mapping.

6. The method of claim 1, wherein the trigger event comprises reception of a radio reconfiguration message indicative of a handover.

7. The method of claim 1, wherein the identifying the second quality of service flows associated with the second radio resources at the target network node comprises mapping data radio bearers at the target network node to second quality of service flows matching or approximating the first quality of service flows.

8. An apparatus for handover continuity, comprising:
at least one processor; and
at least one memory including computer program code, wherein the at least one memory and the computer program code are configured to, with the at least one processor, cause the apparatus at least to
buffer data packets at a user equipment based on a trigger event, wherein the data packets are mapped to first quality of service flows and associated with first radio resources at a source network node;
identify second quality of service flows associated with second radio resources at a target network node;
remap from the first quality of service flows to the second quality of service flows; and
transmit the buffered data packets from the user equipment toward the target network node based on the remapping.

9. The apparatus of claim 8, wherein the at least one memory and the computer program code are further configured to, with the at least one processor, cause the apparatus at least to:
exert flow control on a per-quality-of-service-flow basis on all data packets arriving at a baseband chip of a user equipment, wherein the exerting flow control is responsive to the trigger event.

10. The apparatus of claim 9, wherein the at least one memory and the computer program code are further configured to, with the at least one processor, cause the apparatus at least to:
lift the flow control when a data buffer comprising the buffered data packets drops below a threshold.

11. The apparatus of claim 10, wherein the lifting the flow control comprises selectively lifting flow control on a per-internet-protocol-flow basis based on an association with the second quality of service flows.

12. The apparatus of claim 8, wherein the data packets are mapped to the first quality of service flows using internet protocol flow to quality of service flow mapping.

13. The apparatus of claim 8, wherein the trigger event comprises reception of a radio reconfiguration message indicative of a handover.

14. The apparatus of claim 8, wherein the identifying the second quality of service flows associated with the second radio resources at the target network node comprises mapping data radio bearers at the target network node to second quality of service flows matching or approximating the first quality of service flows.

15. A non-transitory computer-readable medium encoded with instructions that, when executed in hardware of a user equipment, cause the user equipment to perform a process for handover continuity, the process comprising:
buffering data packets at a user equipment based on a trigger event, wherein the data packets are mapped to first quality of service flows and associated with first radio resources at a source network node;
identifying second quality of service flows associated with second radio resources at a target network node;
remapping from the first quality of service flows to the second quality of service flows; and
transmitting the buffered data packets from the user equipment toward the target network node based on the remapping.

16. The non-transitory computer-readable medium of claim 15, the process further comprising:
exerting flow control on a per-quality-of-service-flow basis on all data packets arriving at a baseband chip of a user equipment, wherein the exerting flow control is responsive to the trigger event.

17. The non-transitory computer-readable medium of claim 16, the process further comprising:
lifting the flow control when a data buffer comprising the buffered data packets drops below a threshold.

18. The non-transitory computer-readable medium of claim 17, wherein the lifting the flow control comprises selectively lifting flow control on a per-internet-protocol-flow basis based on an association with the second quality of service flows.

19. The non-transitory computer-readable medium of claim 15, wherein the data packets are mapped to the first quality of service flows using internet protocol flow to quality of service flow mapping.

20. The non-transitory computer-readable medium of claim 15, wherein the trigger event comprises reception of a radio reconfiguration message indicative of a handover.
